(19) United States
(12) Patent Application Publication
(10) Pub. No.: US 2026/0338102 A1
(43) Pub. Date: Oct. 29, 2026

(54) A TURBOMACHINE

(71) Applicant: APUGENIUS OY, LAPPEENRANTA (FI)

(72) Inventors: Matti MALKAMÄKI, LAPPEENRANTA (FI); Juha PYRHÖNEN, LAPPEENRANTA (FI)

(21) Appl. No.: 19/109,070

(22) PCT Filed: Sep. 5, 2023
(86) PCT No.: PCT/FI2023/050505

§ 371 Date: Mar. 5, 2025

(30) Foreign Application Priority Data
Sep. 13, 2022 (FI) 20225796

(51) Int. Cl. F02C 6/00; F02C 7/08; F04D 17/12; F04D 29/056; F04D 29/063; F04D 29/28; F04D 29/58

(52) U.S. Cl. CPC F02C 6/00; F02C 7/08; F04D 17/12; F04D 29/056; F04D 29/063; F04D 29/286; F04D 29/582

(57) ABSTRACT

A turbomachine comprises a first stage (101) comprising a first radial impeller (103), a second stage (102) comprising a second radial impeller (104), a connection channel (109) configured to form a fluid transfer connection between the first and second stages, a shaft (110) attached to the first and second radial impellers, and a bearing assembly (111) axially between the first and second radial impellers and configured to support the shaft. A back surface of the first radial impeller faces towards the bearing assembly and a back surface of the second radial impeller faces away from the bearing assembly. A frame portion (113) surrounding and mechanically supporting the bearing assembly constitutes an inner wall of an annular channel (112) having an axial fluid transfer connection with the second radial impeller.

### FIELD OF THE DISCLOSURE

The disclosure relates to a turbomachine that comprises at least two radial impellers on a same shaft. Furthermore, the disclosure relates to an electrical turbomachine and to a gas turbine system.

### BACKGROUND

In turbomachines fluid interacts with vanes of one or more impellers to transfer energy between the fluid and the one or more impellers. A turbomachine can be a compressor, a blower, or a pump in which one or more impellers is/are used to increase pressure and/or flow of fluid. Alternatively, a turbomachine can be a turbine in which one or more impellers is/are used to receive energy from fluid. The fluid can be gas or liquid such as for example air, combustion gas, steam, or water.

In a radial turbo-compressor, fluid is received via an axial channel which directs the fluid axially to a radial impeller. The radial impeller is configured to rotate in a casing that directs the fluid from an outer perimeter of the radial impeller to a channel that discharges the fluid. The casing constitutes typically a volute which surrounds the radial impeller and whose cross-sectional flow area increases towards an outlet that is typically tangentially directed. The casing may further constitute a diffuser that converts kinetic energy of the fluid into pressure by gradually slowing down the velocity of the fluid.

In many turbomachines it is advantageous or even necessary to have more than one turbomachine stage each operating at its own pressure range. It is straightforward to implement two or more turbomachine stages with two or more rotating shafts, but this approach is typically too expensive for small systems that need to be cost effective. Therefore, a typical two-stage radial turbo-compressor comprises two radial impellers on a same shaft to achieve a simple and robust construction. In typical radial turbo-compressors, an inlet channel is especially sensitive for pressure and/or flow distortions effecting to the efficiency. Thus, a challenge related to radial turbo-compressors having two radial impellers on the same end of a shaft is that the shaft must go through an inlet channel of one of two compressor stages, and thus this inlet channel cannot be designed as freely as the inlet channel of the other compressor stage, and thereby the efficiency of the first mentioned compressor stage can be lower than that of the other compressor stage.

### SUMMARY

The following presents a simplified summary to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a geometric plane, a non-planar geometric surface, a geometric space, or any other geometric entity that is zero, one, two, or three dimensional.

In accordance with the invention, there is provided a new turbomachine that can be for example a turbo-compressor, a pump, or a blower.

A turbomachine according to the invention comprises:
a first stage comprising a first radial impeller, a first channel having an axial fluid transfer connection with the first radial impeller, and a second channel having a radial fluid transfer connection with the first radial impeller at an outer perimeter of the first radial impeller,
a second stage comprising a second radial impeller, a third channel having an axial fluid transfer connection with the second radial impeller, and a fourth channel having a radial fluid transfer connection with the second radial impeller at an outer perimeter of the second radial impeller,
a connection channel configured to form a fluid transfer connection between the second channel and the third channel,
a shaft on which the first and second radial impellers are attached, and
a bearing assembly axially between the first and second radial impellers and configured to support the shaft.

The above-mentioned first and second radial impellers are installed so that the back surface of the first radial impeller faces towards the bearing assembly and the back surface of the second radial impeller faces away from the bearing assembly. The above-mentioned third channel has an annular portion that constitutes the axial fluid transfer connection with the second radial impeller. A frame portion that surrounds and mechanically supports the bearing assembly constitutes an inner wall of the annular portion of the third channel so that an inner diameter of the annular portion of the third channel that surrounds the bearing assembly is an inner diameter of the vane area of the second radial impeller.

Because the inner diameter of the above-mentioned annular channel portion, and thereby the inner diameter of the vane area of the second radial impeller, are so large that the bearing assembly can be surrounded by the annular channel portion, the annular channel portion can be substantially free from shapes, e.g. changes of the inner diameter, which are non-advantageous from the viewpoint of flow technical properties. Thus, the annular channel portion can be designed to have advantageous flow technical properties. Therefore, in a turbomachine which has two compressor stages having radial impellers on the same end of a shaft and in which the shaft goes through an inlet channel of one of the two compressor stages, this inlet channel can be designed to have advantageous flow technical properties.

In accordance with the invention, there is also provided a new electrical turbomachine that can be for example a turbogenerator.

An electrical turbomachine according to the invention comprises:
a compressor stage being a turbomachine according to the invention,
an electric machine having a stator and a rotor, and
a turbine stage having a turbine impeller.

The rotor of the electric machine is mechanically connected to the rotating parts of the compressor stage and the turbine impeller is mechanically connected to the rotor of the electric machine.

In accordance with the invention, there is also provided a new gas turbine system that comprises:
an electrical turbomachine according to the invention and comprising a compressor stage configured to compress air, an electric machine, and a turbine stage configured to drive the electric machine and the compressor stage, and
a combustion chamber configured to receive fuel and the compressed air, to burn the fuel, and to supply combustion gases to the turbine stage.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features. Furthermore, it is to be understood that the use of “a” or “an”, i.e. a singular form, throughout this document does not exclude a plurality.

The features recited in dependent claims are mutually freely combinable unless otherwise explicitly stated.

### BRIEF DESCRIPTION OF THE FIGURES

Exemplifying and non-limiting embodiments and their advantages are explained in greater detail below in the sense of examples and with reference to the accompanying drawings, in which:

FIG. 1 illustrates a turbomachine according to an exemplifying and non-limiting embodiment,

FIG. 2 illustrates an electrical turbomachine according to an exemplifying and non-limiting embodiment, and

FIG. 3 illustrates a gas turbine system according to an exemplifying and non-limiting embodiment.

### DESCRIPTION OF EXEMPLIFYING AND NON-LIMITING EMBODIMENTS

The specific examples provided in the description below should not be construed as limiting the scope and/or the applicability of the accompanied claims. Lists and groups of examples provided in the description are not exhaustive unless otherwise explicitly stated.

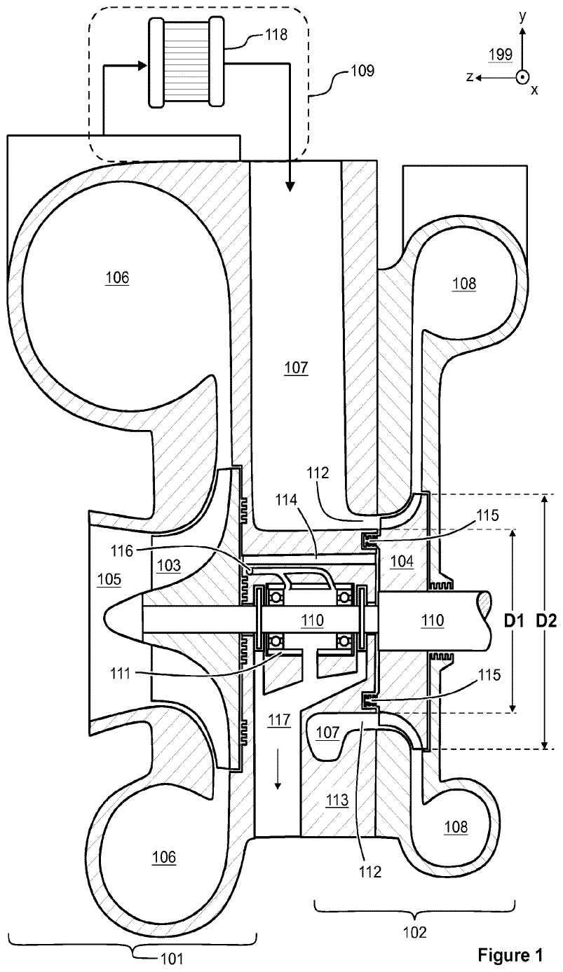

FIG. 1 illustrates a turbomachine according to an exemplifying and non-limiting embodiment. FIG. 1 shows a section view so that a geometric section plane is parallel with the yz-plane of a coordinate system 199. The turbomachine comprises a first stage 101 that comprises a first radial impeller 103, a first channel 105 having an axial fluid transfer connection with the first radial impeller 103, and a second channel 106 having a radial fluid transfer connection with the first radial impeller 103 at an outer perimeter of the first radial impeller 103. In this exemplifying case, the second channel 106 comprises a diffuser for receiving air or some other fluid from the first radial impeller 103 and a volute for receiving the air or some other fluid from the diffuser. The turbomachine comprises a second stage 102 that comprises a second radial impeller 104, a third channel 107 having an axial fluid transfer connection with the second radial impeller 104, and a fourth channel 108 having a radial fluid transfer connection with the second radial impeller 104 at an outer perimeter of the second radial impeller 104. In this exemplifying case, the fourth channel 108 comprises a diffuser for receiving air or some other fluid from the second radial impeller 104 and a volute for receiving the air or some other fluid from the diffuser.

The turbomachine comprises a connection channel 109 configured to form a fluid transfer connection between the above-mentioned second channel 106 and the above-mentioned third channel 107, i.e. to form a series connection of the first and second stages 101 and 102 of the turbomachine. In FIG. 1, the connection channel 109 is shown schematically only.

The turbomachine further comprises a shaft 110 on which the first and second radial impellers 103 and 104 are attached, and a bearing assembly 111 that is axially between the first and second radial impellers 103 and 104 and configured to support the shaft 110. In a turbomachine according to an exemplifying and non-limiting embodiment, the bearing assembly 111 can be for example a commercially available bearing cartridge designed for turbochargers. In a turbomachine according to another exemplifying and non-limiting embodiment, the bearing assembly 111 may comprise one or more active magnetic bearings “AMB”.

As shown in FIG. 1, the first and second radial impellers 103 and 104 are installed so that the back surface of the first radial impeller 103 faces towards the bearing assembly 111 and the back surface of the second radial impeller 104 faces away from the bearing assembly 111. The above-mentioned third channel 107 has an annular portion 112 that constitutes the axial fluid transfer connection with the second radial impeller 104. A frame portion 113 that surrounds and mechanically supports the bearing assembly 111 constitutes an inner wall of the annular portion 112 of the third channel 107. As the inner diameter D1 of the above-mentioned annular portion 112, which is also the inner diameter of the vane area of the second radial impeller 104, is so large that the bearing assembly 111 can be surrounded by the annular portion 112, the annular portion 112 can be substantially free from shapes, e.g. changes of the inner diameter etc., which are non-advantageous from the viewpoint of flow technical properties. The third channel 107 can be designed so that pressure loss in the third channel 107 can be low, e.g.1%, although a flow must make a 90-degrees change of direction in the border area between the annular portion 112 and the rest of the third channel 107. As shown in FIG. 1, structures which constitute walls of the third channel 107 and the frame portion 113 that surrounds and mechanically supports the bearing assembly 111 form a part of the body of the turbomachine.

As shown in FIG. 1, a portion of the second radial impeller 104 that is inside the diameter D1 is significant with respect to a portion of the second radial impeller 104 that comprises the vanes of the second radial impeller 104. Therefore, the second radial impeller 104 has been designed to receive fluid from an annular axial channel, i.e. from the annular portion 112, whose inner diameter D1 is significant with respect to the outer diameter D2 of the second radial impeller 104. In a turbomachine according to an exemplifying and non-limiting embodiment, the ratio of the diameter D1 to the diameter D2, i.e. D1/D2, is in the range from 0.6 to 0.8. In a turbomachine according to an exemplifying and non-limiting embodiment, the ratio D1/D2 is in the range from 0.7 to 0.8. It is to be noted that in a turbomachine according to an exemplifying and non-limiting embodiment whose capacity is higher than the capacity of the turbomachine illustrated in FIG. 1, the outer diameter D2 of the second radial impeller can be so big that the ratio D1/D2 is less than the above-mentioned 0.6.

In a turbomachine according to an exemplifying and non-limiting embodiment, the frame portion 113 has a pressure balancing channel 114 that connects a first space between the back surface of the first radial impeller 103 and the frame portion 113 to a second space between the frame portion 113 and an axially facing front surface of the second radial impeller 104. The pressure balancing channel 114 eliminates or at least reduces an axial pressure difference over the frame portion 113. The axial pressure difference might be harmful as it could cause a fluid flow through the bearing assembly 111 and thereby lubricant oil might get into the second channel 106. FIG. 1 shows one pressure balancing channel 114 but, as evident, there can be two or more pressure balancing channels as well.

In the exemplifying turbomachine illustrated in FIG. 1, the frame portion 113 comprises an inlet oil channel 116 for supplying lubricant oil to the bearing assembly 111 and an outlet oil channel 117 for allowing the lubricant oil to flow out from the bearing assembly 111.

In the exemplifying turbomachine illustrated in FIG. 1, the front surface of the second radial impeller 104 has an annular collar portion 115 that is concentric with the shaft 110 and has radially facing side surfaces configured to face radially towards radially facing surfaces of the frame portion 113. In the exemplifying case shown in FIG. 1, the radially facing side surfaces of the annular collar portion 115 comprise grooves to provide a labyrinth sealing effect to reduce leakage.

In a turbomachine according to an exemplifying and non-limiting embodiment, the connection channel 109 between the first and second stages 101 and 102 comprises an intercooler 118.

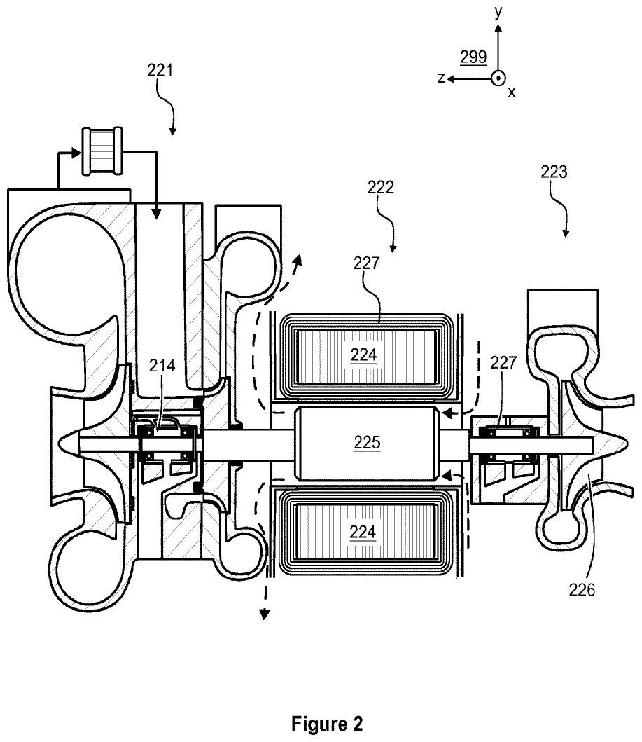

FIG. 2 illustrates an electrical turbomachine according to an exemplifying and non-limiting embodiment. FIG. 2 shows a section view so that a geometric section plane is parallel with the yz-plane of a coordinate system 299. The electrical turbomachine comprises a compressor stage 221 that is a turbomachine according to an embodiment of the invention. The compressor stage 221 can be for example such as the turbomachine presented in FIG. 1. The electrical turbomachine comprises an electric machine 222 having a stator 224 and a rotor 225. The electric machine can be for example an induction machine, a permanent magnet synchronous machine, an electrically excited synchronous machine, or a reluctance machine. The stator 224 can be provided with liquid cooling for example so that the stator 224 is cooled with oil path. The rotor 225 can be cooled with air or some other suitable gas. Gas flows for cooling the rotor 225 are depicted with dashed line arrows in FIG. 2.

The electrical turbomachine comprises a turbine stage 223 having a turbine impeller 226. In this exemplifying electrical turbomachine, the rotor 225 of the electric machine 222 is supported by a bearing assembly 214 of the compressor stage 221 and by a bearing assembly 227 of the turbine stage 223. The bearing assembly 227 of the turbine stage 223 can be like the bearing assembly 214 of the compressor stage 221. In an electrical turbomachine according to an exemplifying and non-limiting embodiment, the bearing assemblies 214 and 227 can be for example commercially available bearing cartridges designed for turbochargers.

In the exemplifying electrical turbomachine illustrated in FIG. 1, the stator 224 of the electric machine 222 comprises drum windings 227 having first coil sides in slots of a stator core and second coil sides on the yoke of the stator core. In many small-power applications, the number of pole pairs of the electric machine 222 is advantageously one in which case drum windings provide shorter end-windings than windings where all coil sides are in slots of a stator core.

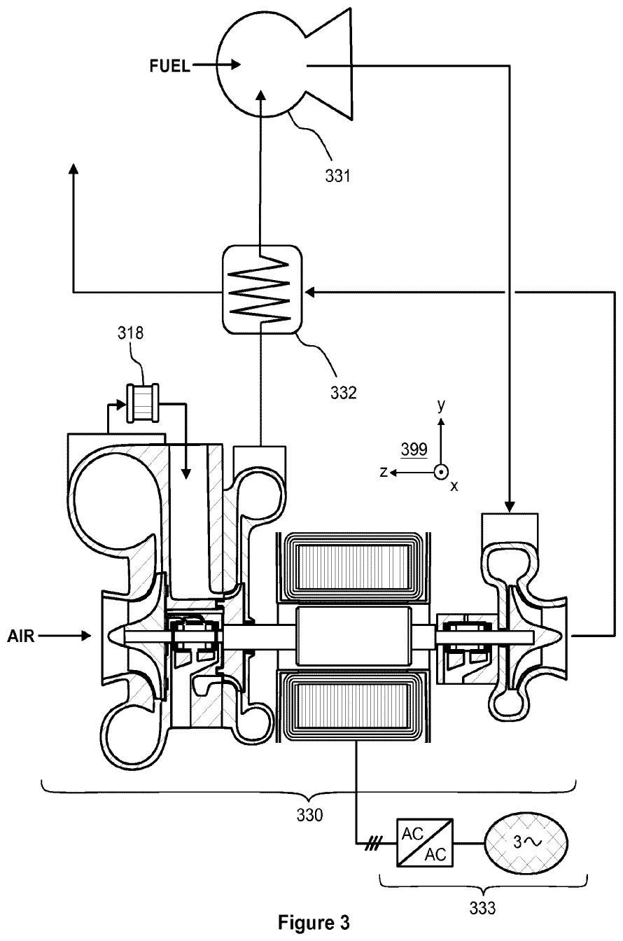

FIG. 3 illustrates a gas turbine system according to an exemplifying and non-limiting embodiment. The gas turbine system comprises an electrical turbomachine 330 according to an embodiment of the invention. The electrical turbomachine 330 can be for example such as the electrical turbomachine presented in FIG. 2. The electrical turbomachine 330 comprises a compressor stage configured to compress air, an electric machine, and a turbine stage configured to drive the electric machine and the compressor stage. In FIG. 3, the electrical turbomachine 330 is shown as a section view so that a geometric section plane is parallel with the yz-plane of a coordinate system 399. The gas turbine system comprises a combustion chamber 331 configured to receive fuel and the compressed air from the compressor stage of the electrical turbomachine 330. The combustion chamber 331 is configured to burn the fuel and to supply the produced combustion gases to the turbine stage of the electrical turbomachine 330. The combustion chamber 331 is presented only schematically in FIG. 3. The electric machine of the electrical turbomachine is connected to an electric system 333 to supply electric power to the electric system 333. In the exemplifying case shown in FIG. 3, the electric system 333 comprises a frequency converter and an alternating voltage power grid. It is also possible that an electric machine of a gas turbine system according to an embodiment of the invention is connected to an electric system that may comprise for example a controllable rectifier and a battery.

A gas turbine system according to an exemplifying and non-limiting embodiment comprises a recuperator 332 configured to receive the combustion gases from the turbine stage, to receive the compressed air from the compressor stage, to transfer heat from the combustion gases to the compressed air, and to supply the heated compressed air to the combustion chamber 331.

In a gas turbine system according to an exemplifying and non-limiting embodiment, the compressor stage of the electrical turbomachine 330 comprises an intercooler 318.

The above-mentioned recuperator 332 and the intercooler 318 improve the efficiency of the gas turbine system.

The specific examples provided in the description given above should not be construed as limiting the scope and/or the applicability of the appended claims. Lists and groups of examples provided in the description given above are not exhaustive unless otherwise explicitly stated.

1. A turbomachine comprising:
a first stage comprising a first radial impeller, a first channel having an axial fluid transfer connection with the first radial impeller, and a second channel having a radial fluid transfer connection with the first radial impeller at an outer perimeter of the first radial impeller,
a second stage comprising a second radial impeller, a third channel having an axial fluid transfer connection with the second radial impeller, and a fourth channel having a radial fluid transfer connection with the second radial impeller at an outer perimeter of the second radial impeller,
a connection channel configured to form a fluid transfer connection between the second channel and the third channel,
a shaft on which the first and second radial impellers are attached, and
a bearing assembly axially between the first and second radial impellers and configured to support the shaft,
wherein a back surface of the first radial impeller faces towards the bearing assembly and a back surface of the second radial impeller faces away from the bearing assembly, and the third channel has an annular portion constituting the axial fluid transfer connection with the second radial impeller, and a frame portion surrounding and mechanically supporting the bearing assembly constitutes an inner wall of the annular portion of the third channel, and an inner diameter of the annular portion of the third channel that surrounds the bearing assembly is an inner diameter of a vane area of the second radial impeller.

2. A turbomachine according to claim 1, wherein a ratio of the inner diameter of the annular portion of the third channel to an outer diameter of the second radial impeller is in a range from 0.6 to 0.8.

3. A turbomachine according to claim 2, wherein the ratio is in a range from 0.7 to 0.8.

4. A turbomachine according to claim 1, wherein the frame portion constituting the inner wall of the annular portion of the third channel has a pressure balancing channel connecting a first space between the back surface of the first radial impeller and the frame portion to a second space between the frame portion and an axially facing front surface of the second radial impeller.

5. A turbomachine according to claim 1, wherein a front surface of the second radial impeller has an annular collar portion concentric with the shaft and protruding axially towards the first radial impeller, the annular collar portion having a radially facing side surface configured to face radially towards a radially facing surface of the frame portion.

6. A turbomachine according to claim 1, wherein the frame portion comprises an inlet oil channel for supplying lubricant oil to the bearing assembly and an outlet oil channel for allowing the lubricant oil to flow out from the bearing assembly.

7. A turbomachine according to claim 1, wherein the connection channel comprises an intercooler.

8. An electrical turbomachine comprising:
a compressor stage,
an electric machine having a stator and a rotor, and
a turbine stage having a turbine impeller,
wherein the rotor of the electric machine is mechanically connected to rotating parts of the compressor stage and the turbine impeller is mechanically connected to the rotor of the electric machine, and the compressor stage is a turbomachine comprising:
a first stage comprising a first radial impeller, a first channel having an axial fluid transfer connection with the first radial impeller, and a second channel having a radial fluid transfer connection with the first radial impeller at an outer perimeter of the first radial impeller,
a second stage comprising a second radial impeller, a third channel having an axial fluid transfer connection with the second radial impeller, and a fourth channel having a radial fluid transfer connection with the second radial impeller at an outer perimeter of the second radial impeller,
a connection channel configured to form a fluid transfer connection between the second channel and the third channel,
a shaft on which the first and second radial impellers are attached, and
a bearing assembly axially between the first and second radial impellers and configured to support the shaft,
wherein a back surface of the first radial impeller faces towards the bearing assembly and a back surface of the second radial impeller faces away from the bearing assembly, and the third channel has an annular portion constituting the axial fluid transfer connection with the second radial impeller, and a frame portion surrounding and mechanically supporting the bearing assembly constitutes an inner wall of the annular portion of the third channel, and an inner diameter of the annular portion of the third channel that surrounds the bearing assembly is an inner diameter of a vane area of the second radial impeller.

9. An electric turbomachine according to claim 8, wherein the stator of the electric machine comprises drum windings.

10. A gas turbine system comprising:
an electrical turbomachine comprising a compressor stage configured to compress air, an electric machine, and a turbine stage configured to drive the electric machine and the compressor stage, and
a combustion chamber configured to receive fuel and the compressed air, to burn the fuel, and to supply combustion gases to the turbine stage,
wherein the electrical turbomachine is an electrical turbomachine comprising:
the compressor stage,
the electric machine having a stator and a rotor, and
the turbine stage having a turbine impeller,
wherein the rotor of the electric machine is mechanically connected to rotating parts of the compressor stage and the turbine impeller is mechanically connected to the rotor of the electric machine, and the compressor stage is a turbomachine comprising:
a first stage comprising a first radial impeller, a first channel having an axial fluid transfer connection with the first radial impeller, and a second channel having a radial fluid transfer connection with the first radial impeller at an outer perimeter of the first radial impeller,
a second stage comprising a second radial impeller, a third channel having an axial fluid transfer connection with the second radial impeller, and a fourth channel having a radial fluid transfer connection with the second radial impeller at an outer perimeter of the second radial impeller,
a connection channel configured to form a fluid transfer connection between the second channel and the third channel,
a shaft on which the first and second radial impellers are attached, and
a bearing assembly axially between the first and second radial impellers and configured to support the shaft,
wherein a back surface of the first radial impeller faces towards the bearing assembly and a back surface of the second radial impeller faces away from the bearing assembly, and the third channel has an annular portion constituting the axial fluid transfer connection with the second radial impeller, and a frame portion surrounding and mechanically supporting the bearing assembly constitutes an inner wall of the annular portion of the third channel, and an inner diameter of the annular portion of the third channel that surrounds the bearing assembly is an inner diameter of a vane area of the second radial impeller.

11. A gas turbine system according to claim 10, wherein the gas turbine system comprises a recuperator configured to receive the combustion gases from the turbine stage, to receive the compressed air from the compressor stage, to transfer heat from the combustion gases to the compressed air, and to supply the heated compressed air to the combustion chamber.

12. A gas turbine system according to claim 10, wherein the compressor stage of the electrical turbomachine comprises an intercooler.

13. A turbomachine according to claim 2, wherein the frame portion constituting the inner wall of the annular portion of the third channel has a pressure balancing channel connecting a first space between the back surface of the first radial impeller and the frame portion to a second space between the frame portion and an axially facing front surface of the second radial impeller.

14. A turbomachine according to claim 3, wherein the frame portion constituting the inner wall of the annular portion of the third channel has a pressure balancing channel connecting a first space between the back surface of the first radial impeller and the frame portion to a second space between the frame portion and an axially facing front surface of the second radial impeller.

15. A turbomachine according to claim 2, wherein a front surface of the second radial impeller has an annular collar portion concentric with the shaft and protruding axially towards the first radial impeller, the annular collar portion having a radially facing side surface configured to face radially towards a radially facing surface of the frame portion.

16. A turbomachine according to claim 3, wherein a front surface of the second radial impeller has an annular collar portion concentric with the shaft and protruding axially towards the first radial impeller, the annular collar portion having a radially facing side surface configured to face radially towards a radially facing surface of the frame portion.

17. A turbomachine according to claim 4, wherein a front surface of the second radial impeller has an annular collar portion concentric with the shaft and protruding axially towards the first radial impeller, the annular collar portion having a radially facing side surface configured to face radially towards a radially facing surface of the frame portion.

18. A turbomachine according to claim 2, wherein the frame portion comprises an inlet oil channel for supplying lubricant oil to the bearing assembly and an outlet oil channel for allowing the lubricant oil to flow out from the bearing assembly.

19. A turbomachine according to claim 3, wherein the frame portion comprises an inlet oil channel for supplying lubricant oil to the bearing assembly and an outlet oil channel for allowing the lubricant oil to flow out from the bearing assembly.

20. A turbomachine according to claim 4, wherein the frame portion comprises an inlet oil channel for supplying lubricant oil to the bearing assembly and an outlet oil channel for allowing the lubricant oil to flow out from the bearing assembly.
